(19) United States
(12) Patent Application Publication
(10) Pub. No.: US 2011/0074634 A1
(43) Pub. Date: Mar. 31, 2011

(54) WIRELESS POSITIONING METHOD AND APPARATUS

(75) Inventors: Geon Min Yeo, Daejeon (KR); Byung-Han Ryu, Daejeon (KR); Hyeong Jun Park, Daejeon (KR); Jisoo Park, Daejeon (KR); Sook Jin Lee, Daejeon (KR)

(73) Assignee: Electronics and Telecommunications Research Institute, Daejeon (KR)

(21) Appl. No.: 12/895,045

(22) Filed: Sep. 30, 2010

(30) Foreign Application Priority Data
Sep. 30, 2009 (KR) 10-2009-0093230
Sep. 30, 2010 (KR) 10-2010-0095192

(51) Int. Cl. G01S 3/02

(52) U.S. Cl. 342/458; 342/463

(57) ABSTRACT

A wireless positioning method of a receiver is provided. Signals are received from a plurality of transmitters, propagation taps of the plurality of transmitters received from the plurality of transmitters are determined, respectively, the distance between the receiver and each of the transmitters is calculated, respectively, the distances are corrected by using propagation delay taps of the respective transmitters to determine final distances between the receiver and each of the transmitters, and an area, in which circles away by the final distances between the receiver and each of the transmitters on the basis of the center of each of the transmitters overlap with each other, is estimated as the location of the receiver. Thus, an error of wireless positioning according to a propagation environment can be reduced.

### CROSS-REFERENCE TO RELATED APPLICATION

This application claims priority to and the benefit of Korean Patent Application No. 10-2009-0093230 and 10-2010-0095192 filed in the Korean Intellectual Property Office on Sep. 30, 2009 and Sep. 30, 2010, the entire contents of which are incorporated herein by reference.

### BACKGROUND OF THE INVENTION

(a) Field of the Invention

The present invention relates to wireless positioning method and apparatus and, more particularly, to a method and apparatus for measuring the location of a terminal on the basis of a type of propagation delay.

(b) Description of the Related Art

A wireless positioning technique is measuring the location of a terminal in a wireless communication system, and recently, as demand for a location-based service (LBS) is increasing, an applied sector of the wireless positioning technique is expanding. In particular, the wireless positioning technique is getting popular according to the growing demand for a technique of detecting a situation or the location of a user and providing an appropriate service to the user.

A global positioning system (GPS), a representative positioning technique, provides positioning results of a high level of accuracy, but with a problem in that a terminal in an indoor area is not able to receive a GPS signal and it can receive the GPS signal only when a GPS receiver is mounted in the terminal.

Thus, a received signal strength indicator (RSSI) method and a time difference of arrival (TDOA) method are considered as alternative wireless positioning techniques. The RSSI method is acquiring location information by using the strength of a reception signal. According to the RSSI method, location information can be acquired because it has a simple structure, but an excessive error occurs due to a path loss.

The TDOA method is acquiring location information by using the time differences of arrival. According to the TDOA method, time synchronization between a receiver and a transmitter are not required, but transmitters must be necessarily synchronized in time.

The foregoing wireless positioning techniques, namely, the GPS, the RSSI method, and the TDOA method, have a problem in that they lack an ability of providing accurate positioning results in a non-line of sight (NLOS) environment or an environment in which a channel state is poor. Thus, a method for providing accurate positioning results reflecting a signal propagation environment is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wireless positioning method and apparatus in consideration of a type of propagation delay. In particular, the present invention provides a wireless positioning method and apparatus having advantages of minimizing a positioning error in a non-line of sight (NLOS) environment.

An exemplary embodiment of the present invention provides a wireless positioning method of a receiver, including: receiving signals from a plurality of transmitters; determining a propagation delay tap of each of the plurality of transmitters received from the plurality of transmitters, respectively; calculating the distance between the receiver and each of the transmitters, respectively; correcting the distances by using the propagation delay taps of the respective transmitters to determine a final distance between the receiver and each of the transmitters; and estimating an area, in which circles away by the final distances between the receiver and each of the transmitters on the basis of the center of each of the transmitters overlap with each other, as the location of the receiver.

Another embodiment of the present invention provides a wireless positioning method of a receiver, including: receiving signals from a plurality of transmitters; determining a propagation environment between the receiver and each of the transmitters by using types of propagation delay taps with respect to the signals received from the plurality of transmitters; calculating the distance between the receiver and each of the transmitters, respectively, by using an arrival time of a first reached propagation delay tap among the propagation delay taps of the transmitters; correcting the distances on the basis of the propagation environments to determine a final distance between the receiver and each of the transmitters; and estimating an area commonly satisfying the final distances, as the location of the receiver.

Yet another embodiment of the present invention provides a wireless positioning apparatus of a receiver, including: a propagation environment determining unit configured to determine propagation delay taps with respect to signals transmitted from a plurality of transmitters; a distance calculation unit configured to calculate the distance between the receiver and each of the transmitters; a distance correction unit configured to correct the distances by using the propagation delay taps of the respective transmitters to calculate a final distance between the receiver and each of the transmitters; and a location estimation unit configured to estimate an area, in which circles away by the final distances between the receiver and each of the transmitters on the basis of the center of each of the transmitters overlap with each other, as the location of the receiver.

### BRIEF DESCRIPTION OF THE DRAWINGS

FIGS. 1A to 1D are graphs showing types of propagation delay taps.

FIG. 2 is a schematic block diagram of a wireless positioning apparatus according to an exemplary embodiment of the present invention.

FIG. 3 is a flow chart illustrating the process of a wireless positioning method according to an exemplary embodiment of the present invention.

FIGS. 4A and 4B illustrate how the wireless positioning apparatus calculates the distance between a receiver and a transmitter according to an exemplary embodiment of the present invention.

FIGS. 5A and 5B illustrate how the wireless positioning apparatus calculates the distance between a receiver and a transmitter according to an exemplary embodiment of the present invention.

FIG. 6 is a view illustrating a method for estimating a location by a wireless positioning apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

In the present disclosure, a terminal may be designated as a mobile station (MS), mobile terminal (MT), a subscriber station (SS), a portable subscriber station (PSS), a user equipment (UE), an access terminal (AT), and the like, and include entire or partial functions of the terminal, MS, MT, SS, PSS, UE, AT, and the like.

In the present disclosure, a base station (BS) may be designated as a radio access station (RAS), a Node B, an evolved Node B (eNodeB), a base transceiver station (BTS), a mobile multihop relay (MMR)-BS, and the like, and include the entire or partial functions of the BS, RAS, Node B, eNodeB, BTS, MMR-BS, and the like.

A wireless positioning method and apparatus according to exemplary embodiments of the present invention will now be described with reference to the accompanying drawings.

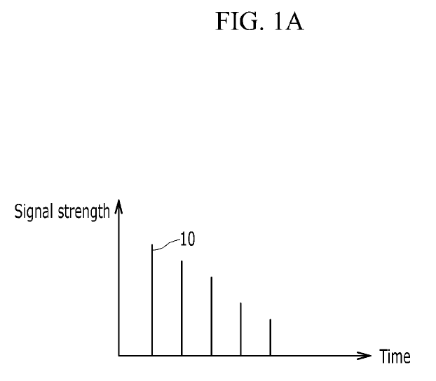

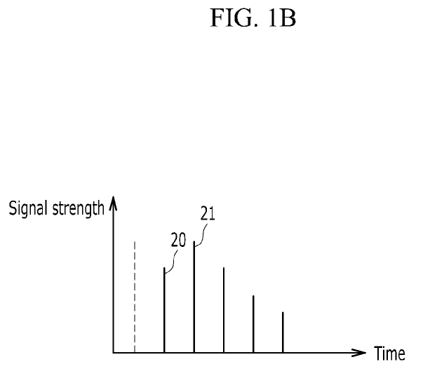

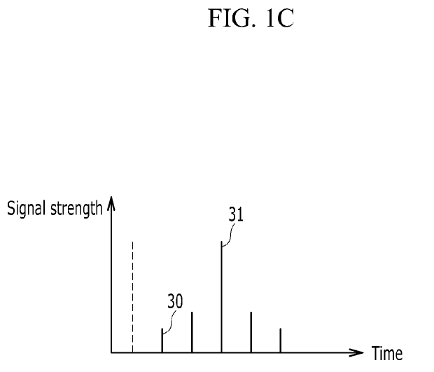

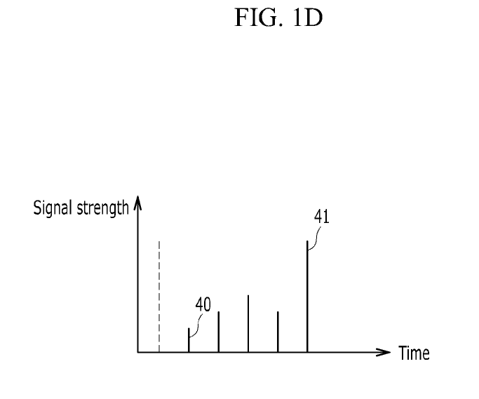

FIGS. 1A to 1D are graphs showing types of propagation delay taps.

A propagation delay tap refers to a signal in a delay spread form after having been transmitted from a transmitter in a multi-path environment. When there is a geographical obstacle between the transmitter and a receiver, multiple paths are formed due to a reflection or diffraction of a signal by the obstacle. Thus, a signal which has been transmitted from the transmitter is delay-spread through the multiple paths.

With reference to FIG. 1A, a signal strength of a propagation tap 10 which has first arrived at the receiver is the greatest. When there is no obstacle between the transmitter and the receiver, a signal, which has been transmitted from the transmitter, can reach the receiver with a high signal strength within a short time. Thus, the type of the propagation delay tap of FIG. 1A may be close to a line of sight (LOS) environment.

With reference to FIG. 1B, a signal strength of a propagation delay tap 21 which has second reached the receiver is the greatest, and a signal strength of a first reached propagation delay tap 20 is smaller than that of the propagation delay tap 21.

With reference to FIG. 1C, a strength of a propagation delay tap 31 which has third reached the receiver is the greatest, and that of a first reached propagation delay tap 30 is smaller than that of the propagation delay tap 31.

With reference to FIG. 1D, a signal strength of a propagation delay tap 41 which has reached the receiver the latest is the greatest, and that of a first reached propagation delay tap 40 is smaller than that of the propagation delay tap 41.

As the type of the propagation delay tap is similar to that of FIG. 1A, the environment between the receiver and the transmitter is close to a line of sight (LOS) environment. As the type of the propagation delay tap is similar to that of FIG. 1D, namely, as an arrival time of the propagation delay tap having the greatest signal strength is delayed, the environment between the transmitter and the receiver is close to a non-line of sight (NLOS) environment.

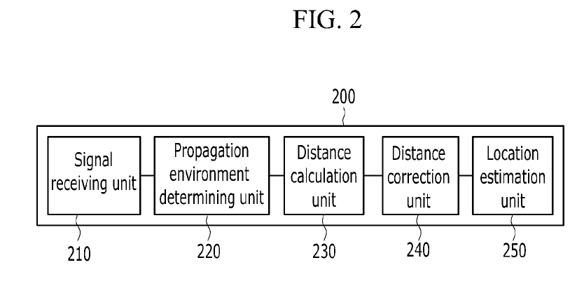

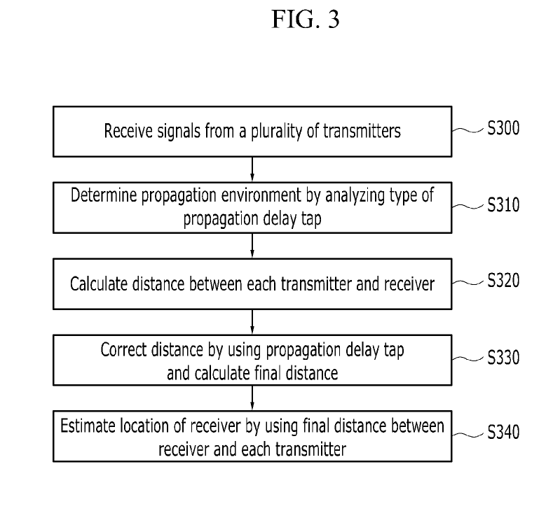

FIG. 2 is a schematic block diagram of a wireless positioning apparatus according to an exemplary embodiment of the present invention, and FIG. 3 is a flow chart illustrating the process of a wireless positioning method according to an exemplary embodiment of the present invention. The wireless positioning apparatus may be a part of the receiver. It is assumed that the wireless positioning apparatus knows about the location of a neighboring transmitter.

With reference to FIG. 2, the wireless positioning apparatus 200 includes a signal receiving unit 210, a propagation environment determining unit 220, a distance calculation unit 230, a distance correction unit 240, and a location estimation unit 250.

With reference to FIGS. 2 and 3, the signal receiving unit 210 receives signals transmitted from a plurality of transmitters (S300). The signals transmitted from the transmitters may be, for example, reference signals for positioning. Hereinafter, a case in which the signal receiving unit 210 receives the reference signals for positioning from the plurality of transmitters will be described as an example,

The propagation environment determining unit 220 determines propagation delay taps with respect to signals transmitted from the plurality of transmitters, and determines a propagation environment on the basis of the propagation delay taps (S310). For example, the propagation environment determining unit 220 selects a propagation delay tap having the greatest signal strength from among the propagation delay taps of the respective transmitters, and when the selected propagation delay tap is the first reached propagation delay tap, the propagation environment determining unit 220 determines that the propagation environment of the corresponding transmitter is an LOS environment. Meanwhile, if the selected propagation delay tap is not the first reached propagation delay tap, the propagation environment determining unit 220 determines that the propagation environment of the corresponding transmitter is an NLOS environment. In this case, as the propagation delay tap having the greatest signal strength reaches later then the other propagation delay taps, the propagation environment determining unit 220 may determine that the propagation environment of the corresponding transmitter has a more NLOS tendency.

The distance calculation unit 230 calculates the distance between each of the transmitters and the receiver (S320). The distance calculation unit 230 may calculate the distance between each of the transmitters and the receiver by using an arrival time of the first reached propagation delay tap among the propagation delay taps of the respective transmitters.

The distance correction unit 240 corrects the distance between the receiver and each of the transmitters by using the propagation delay tap, and calculates a final distance between the receiver and each of the transmitters (S330). For example, when the propagation environment is not the LOS environment, the distance correction unit 240 corrects the distance between the receiver and the corresponding transmitter calculated in step S320. In this case, the distance correction unit 240 may correct the distance by reflecting a delay value according to the NLOS environment. Namely, when the propagation environment of the receiver and the corresponding transmitter is the NLOS environment, the arrival time of the first reached propagation delay tap among the propagation delay taps of the transmitters cannot reflect an accurate propagation delay time. Thus, the distance may be corrected by reflecting the error according to the NLOS environment. As discussed above with reference to FIGS. 1A to 1D, the transition from FIG. 1B to FIG. 1D becomes closer to the NLSO environment, and as the environment is closer to the NLOS environment, an error with respect to the propagation delay time increases. Thus, in case of the LOS environment, an error in the distance between the receiver and each of the transmitters can be corrected by correcting the difference between an estimated arrival time of a propagation delay tap to reach first and an arrival time of the actually first reached propagation delay tap by using a delay tap distribution.

The location estimation unit 250 estimates the location of the receiver by using the final distance between the receiver and each of the transmitters (S340). For example, the location estimation unit 250 may form circles around the respective transmitters on the basis of the center of each of the respective transmitters in which the distance between the receiver and each of the transmitters is radius, and estimate an area, in which the formed circles overlap with each other, as the location of the receiver.

Hereinafter, a detailed method for estimating, by the wireless positioning apparatus, the distance between the receiver and each of the transmitters by using each propagation environment between the receiver and each of the transmitters will now be described. In the following description, a receiver, a target of wireless positioning, receives a reference signal for positioning from a transmitter located near the receiver. The receiver analyzes a type of a propagation delay tap with respect to the reference signal which has been received from the transmitter, and determines a propagation environment between the receiver and the transmitter. In this case, it is assumed that the wireless positioning apparatus of the receiver know about the location of the transmitter.

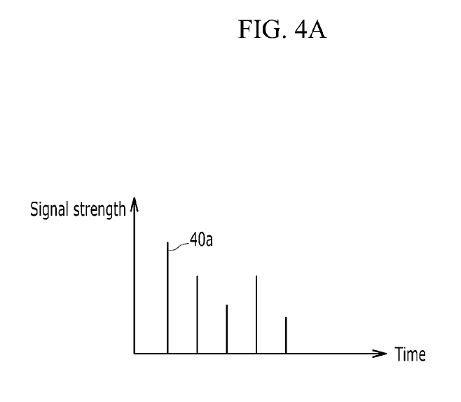

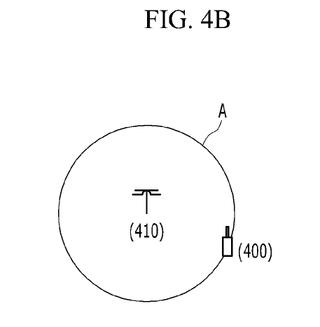

FIGS. 4A and 4B illustrate how the wireless positioning apparatus calculates the distance between a receiver and a transmitter according to an exemplary embodiment of the present invention.

With reference to FIG. 4A, a propagation delay tap 40a having the greatest signal strength, among the propagation delay taps from transmitters 410, has first reached a receiver 400. Thus, it can be estimated that the environment between the receiver 400 and the transmitter is the LOS environment without any obstacle.

With reference to FIG. 4B, when the propagation environment between the receiver 400 and the transmitter 410 is the LOS environment, the distance between the receiver 400 and the transmitter 410 may be calculated by using an arrival time of the first reached propagation delay tap 40a among the propagation delay taps of the transmitters 410 and the speed of light. After the wireless positioning apparatus calculates the distance between the receiver 400 and the transmitter 410, it forms a circle (A) around the transmitter 410 based on the center of the transmitter 410, which is away by the distance between the receiver 400 and the transmitter 410 from the receiver 400.

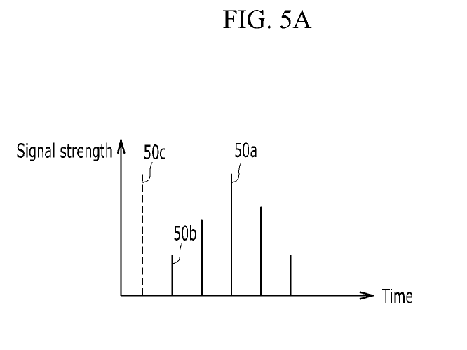

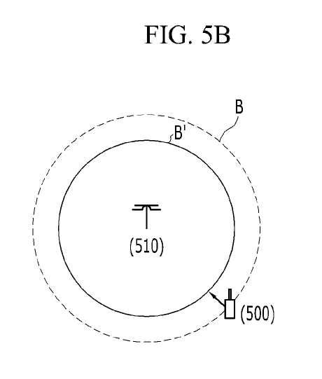

FIGS. 5A and 5B illustrate how the wireless positioning apparatus calculates the distance between a receiver and a transmitter according to an exemplary embodiment of the present invention.

With reference to FIG. 5A, a propagation delay tap 50a having the greatest signal strength, among propagation delay taps received from a transmitter 510, has reached a middle point with respect to the receiver 500. Namely, the first reached propagation delay tap 50b does not have the greatest signal strength. Thus, it can be assumed that the receiver 500 and the transmitter 510 are in an NLOS environment having an obstacle.

With reference to FIG. 5B, when the propagation environment is the LOS environment, an arrival time of the first reached propagation delay tap is even earlier than that in the NLOS environment. Thus, when the propagation environment between the receiver 500 and the transmitter 510 is the NLOS environment, the distance between the receiver 500 and the transmitter 510 may be calculated by using the arrival time of the first reached propagation delay tap 50b, among the propagation delay taps of the transmitters 510, and the speed of light, and then corrected by reflecting a delay value according to the NLOS.

Namely, the wireless positioning apparatus calculates the distance between the receiver 500 and the transmitter 510 by using the arrival time of the first reached propagation delay tap 50b and then forms a circle (B) around the transmitter 510 on the basis of the center of the transmitter 510, which is away by the calculated distance. Because the circle (B) does not reflect the delay value according to the NLOS, it is different from the actual distance between the receiver 500 and the transmitter 510. Thus, a circle (B′) reflecting the delay value according to the NLOS is formed. As for the delay value according to the NLOS, when the propagation environment is the LOS environment, the difference between an estimated arrival time of a propagation delay tap 50c to reach first and an arrival time of a propagation delay tap (b) which has first reached actually can be corrected by using a distribution of the delay taps.

A method for estimating the location of the receiver by using the estimated distance between the receiver and each of the transmitters will now be described.

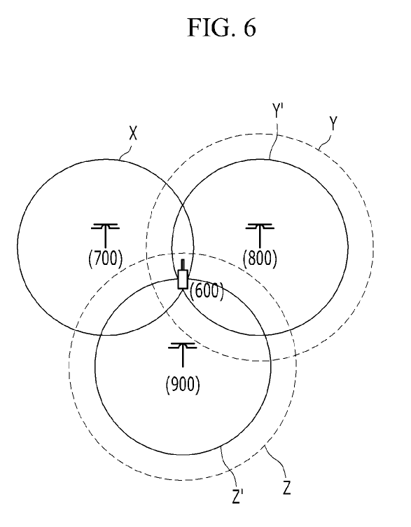

FIG. 6 is a view illustrating a method for estimating a location by a wireless positioning apparatus according to an exemplary embodiment of the present invention.

With reference to FIG. 6, it is assumed that a propagation environment between a transmitter 700 and a receiver 600 is the LOS environment, a propagation environment between a transmitter 800 and the receiver 600 and that between a transmitter 900 and the receiver 600 is the NLOS environment, and the receiver 600 knows about the locations of the respective transmitters 700, 800, and 900.

The wireless positioning apparatus calculates the distance between each of the transmitters 700, 800, and 900 and the receiver 600 by using an arrival time of the first reached propagation delay tap among propagation delay taps of reference signals received from the respective transmitters 700, 800, and 900, and forms circles X, Y, and Z around the transmitters 700, 800, and 900 on the basis of the center of each of the transmitters 700, 800, and 900, having the calculated distance between each of the transmitters 700, 800, and 900 and the receiver 600 equivalent to the radius.

Meanwhile, the wireless positioning apparatus corrects the distance between each of the transmitters 800 and 900 and the receiver 600, in which the propagation environment is the NLOS environment, by reflecting a delay value according to the NLOS, and calculates the final distance between each of the transmitters 700, 800, and 900 and the receiver 600.

Thereafter, the wireless positioning apparatus forms circles X, Y′ and Z′ around the transmitters 700, 800, and 900 on the basis of the center of each of the transmitters 700, 800, and 900 and having the final distance between the receiver 600 and each of the transmitters 700, 800, and 900 as the radius (or equivalent to the radius), and estimates an area, in which the formed circles overlap with each other, as the location of the receiver 600.

In the above description, it is assumed that the receiver receives reference signals for positioning from three transmitters for the sake of brevity, but the technical idea of the present invention is not meant to be limited thereto. The receiver may receive reference signals for positioning from three or more transmitters, and perform positioning on the basis of the received reference signals.

By performing wireless positioning on the basis of the types of the propagation delay taps, an error of wireless positioning caused when the propagation environment is the NLOS environment can be reduced.

According to the wireless positioning method and apparatus according to the exemplary embodiments of the present invention, a positioning error in an NLOS environment can be minimized. Thus, accurate positioning results can be obtained by using wireless communication even in a satellite reception is not easy.

The exemplary embodiments of the present invention are not implemented only through the apparatus and method, but can be implemented through a program realizing the function corresponding to the configurations of the exemplary embodiments of the present invention or a recording medium storing the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wireless positioning method of a receiver, the method comprising:
receiving signals from a plurality of transmitters;
determining a propagation delay tap of each of the plurality of transmitters received from the plurality of transmitters, respectively;
calculating the distance between the receiver and each of the transmitters, respectively;
correcting the distances by using the propagation delay taps of the respective transmitters to determine a final distance between the receiver and each of the transmitters; and
estimating an area, in which circles away by the final distances between the receiver and each of the transmitters on the basis of the center of each of the transmitters overlap with each other, as the location of the receiver.

2. The method of claim 1, wherein the determining of the final distance comprises:
when a first propagation delay tap having the greatest signal strength is a first reached second propagation delay tap among propagation delay taps of the respective transmitters, correcting the distances by using a delay value of the second propagation delay tap.

3. The method of claim 2, wherein when a propagation environment is a line of sight (LOS) environment, the delay value of the second propagation delay tap is the difference between an estimated arrival time of a propagation delay tap to first reach and an actual arrival time of the second propagation delay tap.

4. The method of claim 1, further comprising:
selecting a propagation delay tap having the greatest signal strength among the propagation delay taps of the respective transmitters; and
when the selected propagation delay tap is the first reached propagation delay tap, determining that the propagation environment of a corresponding transmitter is the LOS environment.

5. The method of claim 4, wherein the determining of the final distance comprises:
when the propagation environment is not the LOS environment, correcting the distances in consideration of a delay value according to a non-line of sight (NLOS).

6. The method of claim 1, wherein the calculating of the distances comprises:
calculating the distances by using an arrival time of the first reached propagation delay tap among the propagation delay taps of the respective transmitters.

7. A wireless positioning method of a receiver, the method comprising:
receiving signals from a plurality of transmitters;
determining a propagation environment between the receiver and each of the transmitters by using types of propagation delay taps with respect to the signals received from the plurality of transmitters;
calculating the distance between the receiver and each of the transmitters, respectively, by using an arrival time of a first reached propagation delay tap among the propagation delay taps of the transmitters;
correcting the distances on the basis of the propagation environments to determine a final distance between the receiver and each of the transmitters; and
estimating an area commonly satisfying the final distances, as the location of the receiver.

8. The method of claim 7, wherein the determining of the propagation environment comprises:
selecting a propagation delay tap having the greatest signal strength from among propagation delay taps with respect to the signals received from the respective transmitters;
when the selected propagation delay tap is a first reached propagation delay tap, determining that the propagation environment is a line of sight (LOS) environment; and
when the selected propagation delay tap is not a first reached propagation delay tap, determining that the propagation environment is a non-line of sight (NLOS) environment.

9. The method of claim 8, wherein the determining of the final distances comprises:
correcting the distance of the transmitter whose propagation environment is the NLOS environment, among the plurality of transmitters, by reflecting a delay value according to the NLOS.

10. The method of claim 9, wherein, in correcting the distance by reflecting the delay value according to the NLOS, when the propagation environment is the LOS environment, the difference between an estimated arrival time of a propagation delay tap to first reach and an arrival time of the actually reached first propagation delay tap.

11. The method of claim 7, wherein the calculating of the distances comprises:
calculating the distances by using the arrival time of the first reached propagation delay tap among the propagation delay taps of the respective transmitters.

12. The method of claim 7, wherein the area commonly satisfying the final distances is an area in which circles set based on the final distances between each of the transmitters and the receiver overlap with each other.

13. A wireless positioning apparatus of a receiver, the apparatus comprising:
a propagation environment determining unit configured to determine propagation delay taps with respect to signals transmitted from a plurality of transmitters;
a distance calculation unit configured to calculate the distance between the receiver and each of the transmitters;
a distance correction unit configured to correct the distances by using the propagation delay taps of the respective transmitters to calculate a final distance between the receiver and each of the transmitters; and
a location estimation unit configured to estimate an area, in which circles away by the final distances between the receiver and each of the transmitters on the basis of the center of each of the transmitters overlap with each other, as the location of the receiver.

14. The apparatus of claim 13, wherein the distance calculation unit calculates the distances by using an arrival time of a first reached propagation delay tap among the propagation delay taps of the respective transmitters.

15. The apparatus of claim 14, wherein the propagation environment determining unit selects a propagation delay tap having the greatest signal strength from among the propagation delay taps of the respective transmitters, and when the selected propagation delay tap is a first reached propagation delay tap, the propagation environment determining unit determines that the propagation environment of a corresponding transmitter is a line of sight (LOS) environment.

16. The apparatus of claim 15, wherein when the propagation environment is not the LOS environment, the distance correction unit corrects the distance in consideration of a delay value according to a non-line of sight (NLOS).
